(19) United States
(12) Patent Application Publication
(10) Pub. No.: US 2007/0295750 A1
(43) Pub. Date: Dec. 27, 2007

(54) Combined Machine For The Production Of Both Plain And Syrup-Dressed Ice Cream And Shakes

(75) Inventors: Gino Cocchi, Bologna (IT); Gianni Zaniboni, Borgonuovo Di Sasso Marconi (IT)

Correspondence Address: Timothy J. Klima;Harbin King & Kilma, 500 Ninth Street, SE, Washington, DC, 20003, US

(73) Assignee: ALI S.p.A. - Carpiglani Group, Anzola Emilia (Bologna) (IT)

(21) Appl. No.: 10/577,831

(22) PCT Filed: Oct. 25, 2004
(86) PCT No.: PCT/EP04/52647

§ 371 Date: Feb. 28, 2007

(30) Foreign Application Priority Data
Oct. 29, 2003 (IT) GE2003A000084

(51) Int. Cl. B67D 5/60

(52) U.S. Cl. 222/145.6

(57) ABSTRACT

Combined machine for the production of both ice cream and shakes, comprising a refrigerating unit, a freezing chamber (3) equipped internally with a stirrer, a tank (6) for the liquid ice cream mixture supplied into the freezing chamber (3), and a 5 dispensing hatch which closes the front end of the freezing chamber (3). Said hatch (7) comprises a cylinder (12) provided with a radial aperture (24) communicating with the freezing chamber (3) and provided, downstream of said aperture (24), with a plurality of radial apertures (21, 22, 23) communicating, via pumps (208, 209, 209′) arranged in between, with tanks (8, 9, 9) containing respectively a diluting liquid and one or more dressing syrups; a tubular piston (13) sliding inside this cylinder from a first rest position ii which it closes off both said apertures (21, 22, 23) and said aperture (24) into a second position in which it opens all these apertures; means for actuating said piston; a spindle (17) supported in a rotatable and axially slidable manner inside the tubular duct of said piston (13) and provided at one end with a small rotor (20) housed inside a flared compartment (112) of the end of said cylinder (12) upstream of said dispensing nozzle (28); and means for performing rotation of said spindle (17).

The present invention relates to a combined self-pasteurising machine suitable for the production of both ice cream and ice cream shakes.

At present machines able to supply shakes and ice cream are known, but these machines have two separate hatches and very often also two separate freezing cylinders.

The object of the present invention therefore is to provide a machine for the production of ice cream of the abovementioned type which has a hatch with a single outlet, but with the possibility of numerous variations of the base product, such as for example:

1) Plain-based ice cream;

2) Various ice cream with the possibility of choosing from several flavours of syrup;

3) Various ice cream mixed simultaneously with two differently coloured syrups;

4) Plain shake;

5) Shake mixed with a choice of syrups.

Further characteristics and advantages of the machine according to the present invention will emerge more clearly from the following description of a preferred embodiment thereof, provided with reference to the accompanying drawings, in which:

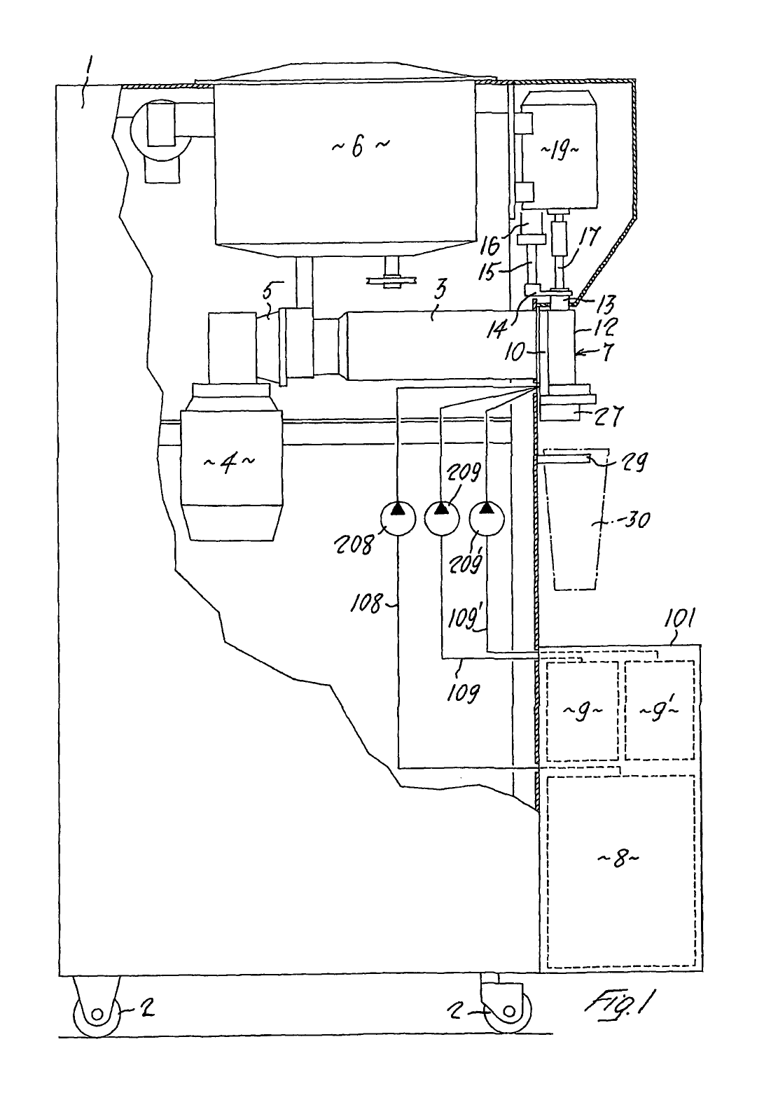

FIG. 1 is a partially sectioned and partially schematic side elevation view of a machine according to the invention;

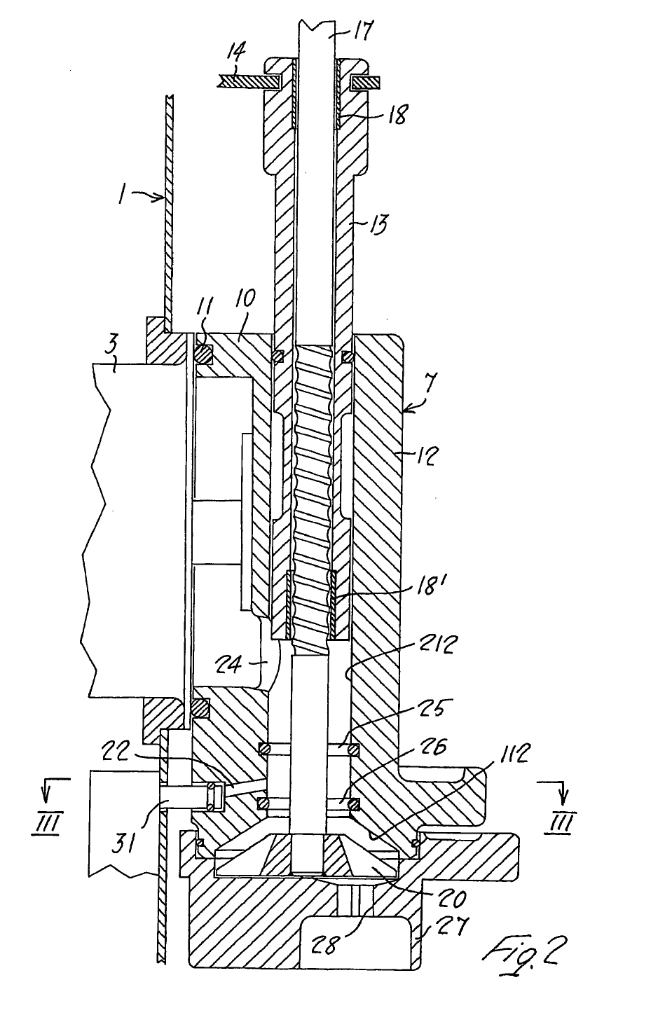

FIG. 2 is a detail, on a larger scale, of the ice cream and/or shake dispensing hatch of the machine according to FIG. 1, and

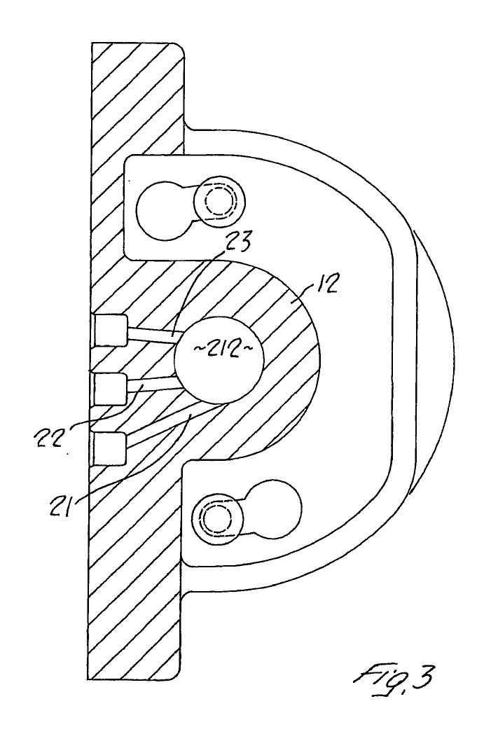

FIG. 3 is a detail, on a larger scale, of the hatch according to FIG. 2 sectioned along the line III-III in FIG. 2.

With reference to the drawings and with particular reference to FIG. 1 thereof, the machine shown comprises a housing 1 preferably mounted on wheels 2, the bottom of which contains the refrigerating unit (not shown) comprising in a known manner a motorized compressor and a condenser, while the evaporator surrounds the freezing chamber 3 provided internally, in a known manner, with a stirrer operated by the motor 4 via a reduction gear unit 5. 6 denotes the tank storing the liquid mixture which is supplied, via a special pump (not shown), in the rear part of the freezing chamber 3. The front end of freezing chamber 3 is closed by a hatch, denoted generally by 7. A compartment 101—preferably refrigerated—of the housing 1 of the machine described contains a tank 8 for a diluting liquid for making shake, which may be water or milk, or a mixture thereof, and two (or more) tanks 9, 9′ containing a corresponding number of dressing syrups. Pipes 108, 109 and 109′ connect, via pumps 208, 209, 209′ arranged in between, the tanks 8,9 and 9′ to the hatch 7, as will be described more fully below.

With reference to FIG. 2, the hatch 7 of the machine according to the invention will now be described.

This hatch 7 comprises a base plate 10 which is fixed to the housing 1 of the machine for example by means of bolts (not shown) and which sealingly closes, by means of the toroidal seal 11, the mouth of the whipping chamber 3. This plate 10, which is generally made of plastic, supports as one piece therewith a cylindrical element 12 inside the internal cavity 212 of which a tubular piston 13 slides. The top end of the piston 13 is connected, via an arm-piece 14, to the stem 15 of an actuator 16 which may be for example a pneumatic cylinder able to impart to the piston 13 a stroke in alternating directions inside the cylinder 12, for the purposes which will be described below. A spindle 17 Is guided in a rotating and axially slidable manner inside the tubular duct of the piston 13, sealing means 18, 18′ being fixed to the walls of the tubular duct of the piston 13 at the two ends of this piston so as to ensure both a rotational and a sliding seal between the spindle 17 and the tubular duct of the piston 13. The spindle 17 is rotationally actuated by a two-speed electric motor 19 for the purposes which will be described below.

At its bottom end, the tubular duct of the cylinder 12 has a flared portion delimiting a chamber 112 and this chamber 112 houses inside it a propeller or rotor element 20 keyed onto the bottom end of the spindle 17.

A hole 24 is formed in the middle zone of the wall of the cylindrical element 12 and connects this cylinder 12 to the whipping chamber 3.

The cylinder 12 has formed, in the vicinity of Its bottom end, several ducts 21, 22, 23 connecting the exterior and the internal chamber of the cylinder 12, and the delivery branches of the lines 108, 109, 109′ from the volumetric pumps 208, 209, 209′ are connected sealingly to said ducts 21, 22, 23 by means of unions 31. Upstream and downstream of the zone where the ducts 21, 22 and 23 emerge inside the cylinder 12, the internal walls of the cylindrical chamber 212 are provided with two annular seals 25, 26 for the purposes which will be described below. The end of the cylinder 12 is closed by an element 27 of a dispensing nozzle 28 situated in an eccentric position with respect to the rotor 20.

Advantageously means 29 for supporting, for example, a cup 30 are provided below the nozzle 28.

The operating principle of the machine described above will appear obvious.

With the piston 13 completely lowered, namely in the position where the head of the piston 13 is situated flush with the start of the flared portion 112 of the cylinder 12, the piston 13 closes off all the apertures 21, 22 and 23 dispensing the dressing syrups and the milk from the tanks 8, 9 and 9′, and the aperture 21 communicating with the whipping cylinder 3. The motor 19 is at a standstill and the machine is in the rest position. If it is required to dispense a quantity of product, the operator chooses from a special selector (not shown) the desired operation, i.e. for example:

Button (a)—plain-based ice cream;

Button (b) or button (b′)—various ice cream with the possibility of choosing the syrup (9) or the syrup (9′);

Button (c)—various ice cream mixed simultaneously with the two syrups (9) and (9′);

Button (d)—plain shake;

Button (e) or button (e′)—shake mixed with a choice of syrup (9) or (9′).

If option (a) is chosen, namely dispensing of a plain ice cream, the actuator 16 raises, by means of the stem 15 and the arm 14, the piston 13 substantially into the position shown in FIG. 1. The pumps 208, 209 and 209′ are not activated, while the motor 19 is made to operate at a low number of revolutions and simultaneously the stirrer (not shown) is activated inside the whipping chamber 3 so that the ice cream contained inside this chamber is made to flow through the aperture 24 into the chamber 112 of the cylinder 12 downstream of the piston 13. Practically simultaneously an electronic control unit (not shown) of the machine starts the downward stroke of the piston 13 so that the ice cream is pushed towards the rotor 20 and from here is supplied to the dispensing nozzle 28 which dispenses it for example on top of a cone or other suitable container (not shown). When the piston reaches its initial position, the machine returns into the rest condition.

If one of the buttons b, b′ or c is activated, the same steps described above are repeated together with the fact that, depending on the selection performed, the volumetric pump 209 or 209′ or both of them are activated so as to supply, via the duct 22 or 23 or both of them, the dressing syrup from the tanks 9, 9′ onto the ice cream being dispensed.

If button d is activated, dispensing of a plain shake is performed. In this case, the ice cream dispensing operation described is repeated, with the difference that the motor 19 is made to rotate at a high speed and the volumetric pump 208 is activated so as to supply, via the duct 21, the milk (or water depending on the circumstances) from the tank 8 into the ice cream which is being dispensed, so that, owing to the rotor 20 operating at a high speed, the milk and ice cream are emulsified in a homogeneous manner, resulting in a plain shake which is dispensed from the nozzle 28 for example into the underlying cup 30.

Finally, if the button e or e′ is activated, the shake dispensing operation described above is repeated, with the sole difference that a syrup is also dispensed from one of the tanks 9 or 9′ together with the milk.

Obviously the present invention is not limited to the embodiments illustrated and described. Thus, for example, it is possible to envisage a step involving washing of the ice cream dispensing zone, during which the piston 13 is raised to the level of the seal 25 so as to prevent dispensing of ice cream, and water is supplied from a tank (which could also be the tank 8) via the duct 21 (or via an additional duct provided for this purpose), activating at the same time the rotor 20 so that washing of the ice cream dispensing zone is obtained.

Moreover, pumps of another type, such as for example peristaltic pumps may be envisaged instead of the volumetric pumps 208, 209, 209′ or alternatively the tanks containing both the diluting liquid 8 and the syrups 9,9′ may be of the pressurised type so as to supply these products pneumatically.

1. Combined machine for the production of both plain and syrup-dressed ice cream and shakes, of the type comprising a refrigerating unit, a freezing chamber (3) cooled by the evaporator of said refrigerating unit and provided internally with a stirrer, a tank (6) for the liquid ice cream mixture supplied into the freezing chamber (3) and a dispensing hatch which closes the front end of the freezing chamber (3), characterized in that said hatch (7) comprises a cylinder (12) provided with a radial aperture (24) communicating with the freezing chamber (3) and provided downstream of said aperture (24) with a plurality of radial apertures (21,22, 23) communicating, via pumps (208,209, 209′) arranged in between, with tanks (8,9, 9′) containing respectively a diluting liquid and one or more dressing syrups, a tubular piston (13) sliding in this cylinder from a first rest position in which it closes off both said apertures (21,22, 23) and said aperture (24), into a second position in which it opens all these apertures; means for actuating said piston; a spindle (17) which is supported in a rotatable and axially slidable manner inside the tubular duct of said piston (13) and provided at one end with a small rotor (20) housed inside a flared compartment (112) of the end of said cylinder (12) upstream of said dispensing nozzle (28); and means for performing rotation of said spindle(1 7).

2. Combined machine according to claim 1, in which said diluting liquid is water or milk.

3. Combined machine according to claim 1, in which said pumps (208,209, 209′) are volumetric pumps.

4. Combined machine according to claim 1, in which said pumps (208,209, 209′) are peristaltic pumps.

5. Combined machine according to claim 1, in which said diluting liquids and/or said syrups are supplied pneumatically from said tanks (8,9, 9′) to said radial apertures (21,22, 23).

6. Combined machine according to claim 1, in which said means for actuating the piston (13) comprise a pneumatic or oil type cylinder (16) which slidably houses a piston, the stem (15) of which engages, by means of a union (14), with the end of said piston (13).

7. Combined machine according to claim 1, in which said means for actuating the spindle (17) comprise a two-speed motor (19).

8. Combined machine according to claim 1, comprising a selector connected to a control unit which operates the pumps (208,209, 209′); the motor (4) of the stirrer of the freezing chamber (3); the motor (19) of the rotor (20) and the double-acting cylinder actuating the piston (13).

9. Machine according to claim 8, in which said selector has a plurality of buttons which allow the following options:
dispensing of a plain-based ice cream;
dispensing of various ice cream with the possibility of choosing the syrup (9) or the syrup (9′);
dispensing of various ice cream mixed simultaneously with the two syrups (9) and (9′):
dispensing of a plain shake;
dispensing of a shake mixed with a choice of syrup (9) or (9′).

10. Machine according to claim 9, in which, when dispensing of the plain-based ice cream is selected, the motor (4) operates the stirrer of the freezing chamber (3), the motors of the pumps (208,209, 209′) are not activated, and the motor (19) operates at low speed the spindle (17) operating the rotor (20) and the device (14, 15,16) actuating the piston (13) raises firstly said piston above the aperture (24) and then moves it back down so as to expel outside the ice cream contained inside the cylindrical chamber (212), via the dispensing nozzle (28), assisted during this operation by the action of the rotor (20).

11. Machine according to claim 10, in which, when dispensing of an ice cream dressed with one or more syrups (9,9′) is selected, the steps according to claim 8 are repeated, with operation also, however, of the pumps (209 and/or 209′) so as to supply a dose of one or more syrups (9,9′) onto the ice cream which is being dispensed.

12. Machine according to claim 9, in which, when the dispensing of a shake is selected, all the operations according to claim 9 are activated, together with the fact that the pump (208) for delivering a liquid diluant (8) (milk and/or water) is activated and the motor (19) is made to rotate at high speed.

13. Machine according to claim 12, in which, when dispensing of a shake with an added syrup is selected, the operations according to claim 10 are activated, together with the fact that one of the pumps (209, 209′) delivering a syrup (9,9′) is also activated.

14. Machine according to claim 9, in which, when dispensing of a shake with an added syrup is selected, the operations according to claim 10 are activated, together with the fact that one of the pumps (209, 209′) delivering a syrup (9,9′) is also activated.

15. Machine according to claim 9, in which, when dispensing of an ice cream dressed with one or more syrups (9,9′) is selected, the steps according to claim 8 are repeated, with operation also, however, of the pumps (209 and/or 209′) so as to supply a dose of one or more syrups (9,9′) onto the ice cream which is being dispensed.

16. Combined machine according to claim 2, comprising a selector connected to a control unit which operates the pumps (208,209, 209′); the motor (4) of the stirrer of the freezing chamber (3); the motor (19) of the rotor (20) and the double-acting cylinder actuating the piston (13).

17. Combined machine according to claim 3, comprising a selector connected to a control unit which operates the pumps (208,209, 209′); the motor (4) of the stirrer of the freezing chamber (3); the motor (19) of the rotor (20) and the double-acting cylinder actuating the piston (13).

18. Combined machine according to claim 4, comprising a selector connected to a control unit which operates the pumps (208,209, 209′); the motor (4) of the stirrer of the freezing chamber (3); the motor (19) of the rotor (20) and the double-acting cylinder actuating the piston (13).

19. Combined machine according to claim 5, comprising a selector connected to a control unit which operates the pumps (208,209, 209′); the motor (4) of the stirrer of the freezing chamber (3); the motor (19) of the rotor (20) and the double-acting cylinder actuating the piston (13).

20. Combined machine according to claim 6, comprising a selector connected to a control unit which operates the pumps (208,209, 209′); the motor (4) of the stirrer of the freezing chamber (3); the motor (19) of the rotor (20) and the double-acting cylinder actuating the piston (13).
